(19) United States
(12) Patent Application Publication
(10) Pub. No.: US 2008/0006587 A1
(43) Pub. Date: Jan. 10, 2008

(54) Method and apparatus for transfer of carbon dioxide gas to an aqueous solution

(76) Inventors: Robert Cumming, Williamsburg, VA (US); Stephen Axtell, Mint Hill, NC (US); Jerry Johns, Gainesville, GA (US); Robert Kim, Wexford, PA (US); Joe Phillips, Barwamsville, VA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 11/703,917

(22) Filed: Feb. 8, 2007

(30) Foreign Application Priority Data
Jul. 6, 2006 (US) PCT/US06/26244

(51) Int. Cl. C02F 1/68; B01D 50/00; C02F 1/66

(52) U.S. Cl. 210/756; 210/198.1; 210/749

(57) ABSTRACT

A method and apparatus are disclosed for injection of carbon dioxide into a process water stream. The method and apparatus allow carbon dioxide injection using any line pressure as it normally exists in a target water stream and produces superior mixing and carbon dioxide transfer results. The benefits of this method and device significantly improve the economics of using carbon dioxide gas to control pH and at the same time reduces the negative impact on the environment caused by the off gassing of carbon dioxide that is not effectively mixed into solution.

### CROSS-REFERENCE TO RELATED APPLICATIONS

This application claims benefit from International Application Serial No. PCT/US2006/026244, filed on Jul. 6, 2006 which claims priority to U.S. Provisional Application Ser. No. 60/697,640 filed, on Jul. 8, 2005.

### TECHNICAL FIELD

This disclosure generally relates to the field of treating potable, process or wastewater so as to reduce and/or control the pH of the water. In particular, the disclosure relates to a method and apparatus for injecting and mixing carbon dioxide gas into waters having a high pH level thereby reducing its pH.

### BACKGROUND OF INVENTION

In various treatment methods of water the resulting potable, process or wastewater may have an impermissible high pH level (pH>9). Unfortunately, an elevated pH is unacceptable for final treated water and therefore the pH must be reduced prior to allowing the treated water into general use. Most water treatment plants are required to maintain an effluent pH of between 6 and 9. Therefore, any water being treated having a pH of higher than about 9 should have its pH lowered before leaving the plant. Additionally, when pH dependent antimicrobial agents commonly used in water treatment, such as chlorine or sodium hypochlorite, are added to water during the treatment process the pH must be lowered, preferably to a range of 6.5-7.0, in order to maximize the antimicrobial benefits of the chlorine or sodium hypochlorite.

One common method for lowering the pH of treated water is to inject carbon dioxide gas into water having an elevated pH. Several prior methods inject the carbon dioxide into the water. One prior method injects carbon dioxide into the water by a direct gas feed through a diffusion system in a re-carbonation basin; in effect, a bubbler. A mechanical mixing means can be used in combination with this method for better efficiency. Unfortunately, this method requires the use of expensive equipment and large amounts of carbon dioxide.

Another prior method for injecting carbon dioxide into water is to aspirate the carbon dioxide into a stream of water using a venturi type eductor. In this method, the carbon dioxide is injected into the stream of water and carried along with the stream of water to a grid system located in a basin or a pipeline. Both the direct feed method and the venturi method of injecting carbon dioxide gas into water allow for the control of the pH and the stabilization of the treated water. However, it is difficult to control the efficiency of the carbon dioxide gas usage with these systems and the mixing process is not efficient which results in significant levels of off gassing. In addition to wasting carbon dioxide due to inefficient mixing, both of these processes require the use of a relatively large contact basin, a relatively long contact time or large amount of carrier water, all of which inherently are inefficient.

A further prior approach is an alternative to the direct feed method and the venturi method utilizes a mixing system, which creates a pressurized environment and forces the mixing of carbon dioxide into water under pressure as disclosed in U.S. Pat. No. 5,487,835 ('835 patent) and U.S. Pat. No. 5,514,264 ('264 patent). The techniques disclosed in the '835 and '264 patent form a supersaturated carbon dioxide and water solution. This supersaturated solution is then introduced into a water stream in such a way that the excess carbon dioxide from the supersaturated stream is released through a diffusion means. These pressurized systems claim to not require a large contact basin as required for the direct feed and venturi methods and also apparently make more efficient use of carbon dioxide as compared to the direct feed and venturi methods. However, the equipment required to create and control such a highly pressurized environment is expensive and not necessarily adaptable to existing water treatment systems.

It is apparent that a method and apparatus is needed that is a direct carbon dioxide injection method and apparatus in which the amount of carbon dioxide injected into the water stream is easily controlled, a contact basin and its resulting cost is not required, and efficient mixing of carbon dioxide into water is achieved without the need for a pressurized mixing environment thereby increasing efficiency and lowering overall cost. A more direct method would result in less off gassing of either poorly mixed or supersaturated water streams resulting in less environmental impact from the release of carbon dioxide gas into the atmosphere. Methods described in the prior approaches accomplish the task of controlling pH by injecting and mixing carbon dioxide into water. However all of these known methods have one or more of the following deficits that translate into higher costs: 1) inefficient mixing and therefore excessive use and/or wasting of carbon dioxide, 2) requirement of a large contact basin, a relatively long contact time or large amounts of carrier water all of which translates into high costs, or 3) utilize pressurized systems which by the nature of their design are expensive both in terms of installed cost but also for operation and maintenance.

### SUMMARY OF INVENTION

According to the invention, rather than re-pressurizing a water stream or modifying existing line pressure, the method and device according to the invention is able to take any line pressure as it normally exists in a target water stream and produce superior mixing and carbon dioxide transfer results. The benefits of this method and device significantly improve the economics of using carbon dioxide gas to control pH and at the same time reduces the negative impact on the environment caused by the off gassing of carbon dioxide that is not effectively mixed into solution.

In one illustrative embodiment according to the invention, a water stream consisting of process water (i.e., potable city water) that is used throughout a poultry processing plant from evisceration through bird-washers is used. The water stream flows through an approximately 6″ diameter main header. A side stream in fluid communication with the main header draws approximately 90 gpm of this water into an approximately 2.5″ diameter pipe, which is referred to as a side stream pipe. The side stream pipe runs for approximately 30 feet. The water stream is drawn into the side stream pipe from the main header under laminar flow conditions by a mixing pump placed at the end of the side stream pipe. The mixing pump (Scot Pump, Model 52, 7.5 HP) pumps the side stream water from the side stream pipe into approximately a 2″ diameter mixing pipe. The water flows through the mixing pipe in a turbulent flow condition. The mixing pump according to the invention is sized to accomplish bubble froth turbulence in the mixing pipe.

According to the invention carbon dioxide is injected into the mixing pipe at a convenient location toward the beginning point of the mixing pipe. In a first illustrative embodiment, the carbon dioxide is injected through a sparger, which produces small bubbles. It is contemplated within the scope of the invention that a venturi rather than the sparger may be used. The combined water stream and carbon dioxide flow through the mixing pipe produces a bubble froth turbulence.

The mixing pipe according to the invention is sized to accomplish a desired velocity and residence time for the mixing of the water and carbon dioxide in bubble froth turbulence. In a first illustrative embodiment, the mixing pipe is approximately 2″ in diameter and approximately 100 feet in length. The mixing pipe has numerous bends in order to fit the pipe within a limited space. While a straight pipe is preferable in order not to negatively impact the bubble froth turbulent mixing, a pipe with bends is acceptable. A pipe with bends, however, needs to be somewhat longer than would otherwise be required if the pipe was straight.

This inventive design resolves the problems presented by the prior art. With this system the mixing of carbon dioxide into water is efficient and requires lower amounts of carbon dioxide to accomplish comparable reductions in pH as compared to methods described in the prior art. This inventive system eliminates the need and related costs for a large contact basin required by previous approaches described in the prior art. Finally, by not requiring the re-pressurization of a water stream or modification of existing line pressures, the method and device is able to take any line pressure as it normally exists in a target water stream and produce superior mixing and carbon dioxide transfer results at much lower costs.

### BRIEF DESCRIPTION OF DRAWINGS

The foregoing and other features and advantages of the present invention will be better understood from the following detailed description of illustrative embodiments, taken in conjunction with the accompanying drawings in which:

FIG. 1 is a schematic diagram of the apparatus according to the invention.

### DETAILED DESCRIPTION OF THE INVENTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

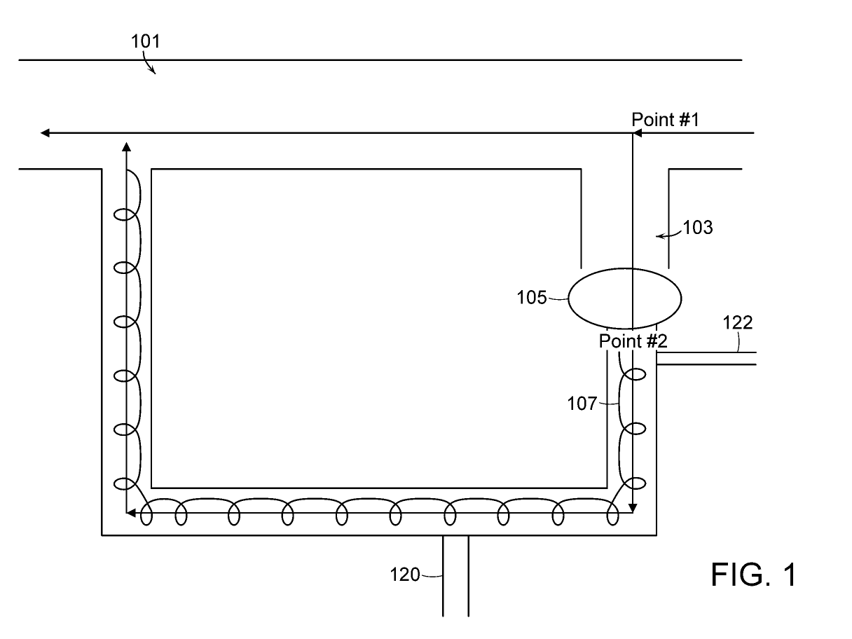

Turning to FIG. 1 the apparatus according to the invention in a first illustrative embodiment comprises a main header pipe 101. The main header pipe 101 can contain various water streams in which it is desirable to infuse carbon dioxide. In the first illustrative embodiment the main header pipe 101 contains a process water stream used in a chicken processing operation. It is contemplated within the scope of the invention that the water stream to be treated can be from any process or potable water source such as a water treatment plant, sewage treatment plant, food or other industrial processing plant, well or municipal potable water line or the like. The main header pipe 101 is approximately 6 inches in diameter and is in fluid communication with a side stream pipe 103. Both the main header pipe 101 and the side stream pipe 103 can be fabricated from a variety of materials such as metals, plastics, glass or the like. The side stream pipe 103 is in fluid communication with a mixing pump 105. The mixing pump 105 (Scot Pump, Model 52, 7.5 HP) is in fluid communication with a mixing pipe 107. The mixing pipe 107 is sized accordingly to create an environment in which there is bubble froth turbulence of process water within the mixing pipe of water drawn from the main header pipe 101. According to the invention, bubble froth turbulence rather than plug flow or slug flow turbulence is desired within the mixing pipe. The bubble froth turbulence within the mixing pipe 101 is at a desired velocity and for a necessary residence time to achieve an efficient mixing of carbon dioxide and water. The velocity of the water in the mixing pipe described herein, which is constructed of stainless steel was approximately ten feet per second. It is contemplated within the scope of the invention that a slightly lower velocity may be acceptable with a mixing pipe made from a different material. The necessary residence time in the mixing pipe will be a function of the diameter of the mixing pipe and is estimated to be within the range of approximately 5 to 10 seconds.

In order to produce the desired bubble froth turbulence mixing for the necessary period of time the diameter and length of the mixing pipe 107 must be sized within certain parameters. These parameters as to the diameter and length of the mixing pipe 107 are determined by the following specifications. The flow rate through the main header pipe 101 is determined. In a first illustrative embodiment the flow rate in the main header pipe is approximately 600 gallons per minute (ppm). According to the invention a Reynolds Number for the flow of water through the mixing pipe 107 constructed of a selected material is determined. The Reynolds Number determines the flow velocity at which bubble froth turbulence will occur. It is contemplated within the scope of the invention that any standard piping material can be used. However, as is known in the art different materials have different surface characteristics which in turn impact the flow rates required to accomplish the desired bubble froth turbulence in the mixing pipe.

The diameter of the mixing pipe 107 and mixing pump 105 size are determined by incorporating the Reynolds Number for the selected piping material for the mixing pipe, volume flows and desired velocity of the flows. In order to inject carbon dioxide into the process water stream via bubble froth turbulence it was found that approximately eight (8) gallons of volume of water to mix approximately one (1) cubic foot of gas or a ratio of 8:1 given an adequate length of the mixing pipe 107. It is contemplated within the scope of the invention that levels below eight gallons to one cubic foot of gas will produce satisfactory bubble froth turbulence.

In the first illustrative embodiment the velocity of the water/gas stream while in bubble froth turbulence in the mixing pipe 107 was approximately ten feet per second.

According to the invention the combination of the factors itemized above allows the determination of the diameter of the mixing pipe 107 as well as the mixing pump 105 size necessary to achieve the desired velocity of approximately ten feet per second or greater through the mixing pipe 107. The desired length of the mixing pipe 107 is a function of the mixing pipe 107 diameter. The mixing pipe 107 diameter is determined by the overall system flow and the mixing pump 105 sizing to achieve a nominal velocity of approximately ten feet/second through the mixing pipe 107. It should be appreciated by one skilled in the art that the larger the mixing pipe 107 diameter the longer the necessary length of the mixing pipe 107. Likewise, it should be further appreciated that the smaller the diameter, the smaller the pipe length. According to the invention, it has been found that multiplying the diameter of the mixing pipe 107 by about 600 will produce an acceptable system (e.g., 600×Diameter=Length). This relationship between mixing pipe diameter and length is summarized in table 1 below:

TABLE 1

| Mixing Pipe Diameter | Mixing Pipe Length |
|---|---|
| 1.0 inches | 600 inches or 50 feet |
| 1.5 inches | 900 inches or 75 feet |
| 2.0 inches | 1,200 inches or 100 feet |
| 2.5 inches | 1,500 inches or 125 feet |
| 3.0 inches | 1,800 inches or 150 feet |

In the first illustrative embodiment the mixing pipe 107 is approximately 100 feet long and constructed of stainless steel.

At a chemical injection point 120 approximately two thirds of the distance from the beginning of the mixing pipe 107, sodium hypochlorite is pumped into the mixing pipe 107. The bubble froth turbulence within the mixing pipe 107 enables desirable mixing of the carbon dioxide, water and sodium hypochlorite. It is contemplated within the scope of the invention that the chemical injection point 120 placed closer to the beginning of the mixing pipe 107 will have a longer available mixing time than one placed further downstream. Such placement of the chemical injection point 120 ensures that a sufficient length of mixing pipe 107 under turbulent flow conditions remains after the injection point 120 to achieve complete mixing of the carbon dioxide, water and sodium hypochlorite.

The mixing pipe 107 further contains a gas injection point 122. In a first illustrative embodiment the gas injection point 122 allows carbon dioxide to be injected into the mixing pipe 107 at the beginning of the mixing pipe 107. In a first illustrative embodiment, the carbon dioxide is injected through a sparger, which produces small bubbles. It is contemplated within the scope of the invention that a venturi rather than the sparger may also be used.

The mixed water side stream then flows through the mixing pipe 107 directly back to the main header pipe 101. According to the invention there is no need to pass this side stream through any sort of diffusion device before it enters the main header pipe 101. The flow from the side stream back to the main header pipe 101 is a direct continuous flow. Accordingly, the inventive apparatus and method does not require the use of a contact basin or system pressurization other than a normal pressure differential required to inject chemicals and reintroduce the side stream into the main header pipe. The inventive apparatus and method allows the utilization of the existing normal pressure in the target water stream without any need for re-pressurization or other modification to the normal line pressure other than to achieve the nominal pressure differential required to overcome line pressures.

The pressure differential in the process described according to the invention can be very small since the only pressure differential required is that necessary to overcome line pressures. Pressure differentials experienced at an illustrative embodiment operating at the poultry processing plant are summarized below:
The main header pipe at the poultry processing plant normally operates at a pressure of approximately 65-70 psig (“Point #1).
After the mixing pump, as the water enters the mixing pipe, the pressure is approximately 75-80 psig (“Point #2”). The pressure at Point #2 must be greater than the pressure at Point #1 in order for the stream of water to be injected back into the main header pipe after it has traveled through the mixing pipe.
The carbon dioxide is injected into the mixing pipe at a pressure of approximately 80-85 psig (“Point #3”). The pressure of Point #3 must be greater than the pressure of Point #2 in order to inject the carbon dioxide into the mixing pipe.
The sodium hypochlorite is injected into the mixing pipe at a pressure that is greater than the pressure of Point #2 in order to inject the sodium hypochlorite into the mixing pipe.

The following example is intended to illustrate various aspects of the present invention, and are not intended to limit the scope of the invention

### EXAMPLE 1

In testing conducted at a poultry processing plant in Cumming Ga., the pH of the water in the main header prior to treatment was approximately 9.25. Following treatment according to the invention the pH was lowered to between 6.5 and 7.0 and controlled at that point.

To accomplish this reduction in pH, approximately 50 cubic feet per hour of carbon dioxide was used. Prior approaches would need between approximately 200-300 cubic feet per hour to accomplish this reduction in pH. Surprisingly, the method and apparatus according to the invention allowed a significantly less amount of carbon dioxide to be used.

In one prior approach disclosed in U.S. Pat. No. 5,487,835 ('835 patent) carbon dioxide usage for a pressurized mixing system is disclosed. The method and apparatus of the '835 patent discloses that a pressurized solution feed system for pH control uses between 0.1 lbs and 10 lbs per unit time of carbon dioxide in 5.0 gallons to 120 gallons per unit time of carrier water. The ratios of carrier water treated per unit of carbon dioxide for these levels are outlined below:

| | Carrier Water | Gal of Carrier |
|---|---|---|
| CO2 (lbs/unit time) | (Gallons/unit time) | Water/lb of CO2 |
| 0.1 | 5 | 50 |
| 10.0 | 120 | 12 |

According to the invention, approximately 50 cubic feet per hour of carbon dioxide in a side stream treats approximately 600 gpm of carrier water in the main header pipe. 50 cubic feet per hour is equivalent to approximately 5.7 lbs per hour. Assuming a flow of 600 gpm in the main header pipe, the hourly flow would be 36,000 (i.e., 600×60) gallons per hour:

| | Carrier Water | Gal of Carrier |
|---|---|---|
| CO2 (lbs/hour) | (Gallons/hour) | Water/lb of CO2 |
| 5.7 | 36,000 | 6315 |

The level of performance achieved by the apparatus and method according to the invention appears to be significantly more effective than the pressurized mixing system described in prior approaches.

Although the illustrative embodiments within this disclosure are directed to the treatment of process water in a poultry processing plant, it should be appreciated by those skilled in the art that the inventive apparatus and method may be used in all applications where carbon dioxide is added to a solution. In addition to mixing carbon dioxide and water, other applications of the inventive apparatus and method include other gas/liquid or liquid/liquid mixing applications examples of which include 1) the mixing into water of other gases commonly used in water treatment such as chlorine gas or ozone, and 2) the mixing into water of liquid chlorine and ammonia to form monochloramine which is used in water treatment.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed:

1. A method for treating aqueous effluent in a processing system comprising:
providing a main header pipe in fluid communication with said aqueous effluent to be treated;
providing a side stream pipe in fluid communication with said main header pipe;
providing a mixing pump in fluid communication with said side stream pipe; and
providing a mixing pipe in fluid communication with said mixing pump said mixing pipe having means for chemical injection and means for gas injection said mixing pipe in further communication with said main header pipe.

2. The method according to claim 1, wherein said means for chemical injection allows the introduction of sodium hypochlorite into said mixing pipe.

3. The method according to claim 1, wherein said means for gas injection allows for the introduction of carbon dioxide into said mixing pipe.

4. The method according to claim 3, wherein said mixing pipe provides bubble froth turbulence of said effluent.

5. The method according to claim 4, wherein said bubble froth turbulence of said effluent allows for the incorporation of said carbon dioxide into said effluent within said mixing pipe.

6. The method according to claim 5, wherein said mixing pipe has numerous bends allowing for a selected velocity and residence time for the mixing of said effluent and said carbon dioxide in a bubble froth turbulence.

7. The method according to claim 1, wherein said effluent within said main header has the normal system pressure of said processing system.

8. The method according to claim 1, wherein said effluent is from a food processing system.

9. The method according to claim 5, wherein said effluent and said carbon dioxide are mixed in said bubble froth turbulence in a ration of approximately 8:1.

10. An apparatus for lowering the pH in a process water treatment plant comprising:
a main header pipe in fluid communication with the process water to be treated;
a side stream pipe in fluid communication with said main header pipe;
a mixing pump in fluid communication with said side stream pipe; and
a mixing pipe having means for chemical injection and means for gas injection said mixing pipe in fluid communication with said mixing pump said mixing pipe in further fluid communication with said main header pipe

11. The apparatus according to claim 10, wherein said mixing pipe is selected to allow bubble froth turbulence of said process water.

12. The apparatus according to claim 10, wherein said process water to be treated is from a food processing plant.

13. A method for mixing a gas into an aqueous solution comprising:
providing a main header pipe in fluid communication with the aqueous solution to be mixed;
providing a side stream pipe in fluid communication with main header pipe said side stream pipe in further fluid communication with a mixing pump; and
providing mixing pipe having means for gas injection said mixing pipe in fluid communication to said mixing pump and in further fluid communication with said main header pipe.

14. The method according to claim 13, wherein said mixing pipe is selected to allow bubble froth turbulence of said aqueous solution.
